(19) United States
(12) Patent Application Publication
(10) Pub. No.: US 2026/0097577 A1
(43) Pub. Date: Apr. 9, 2026

(54) CLAD METAL STRUCTURE

(71) Applicant: HYUNDAI MOBIS CO., LTD., Seoul (KR)

(72) Inventors: Hye Chan PARK, Yongin-si (KR); Jong Mook PARK, Yongin-si (KR); Hyun Jin WOO, Yongin-si (KR); Ho Youn HWANG, Yongin-si (KR)

(73) Assignee: HYUNDAI MOBIS CO., LTD., Seoul (KR)

(21) Appl. No.: 19/308,767

(22) Filed: Aug. 25, 2025

(30) Foreign Application Priority Data
Oct. 8, 2024 (KR) 10-2024-0136814

(51) Int. Cl. B32B 15/01; B23K 9/007; B23K 103/20; B32B 3/26; B32B 7/12

(52) U.S. Cl. CPC B32B 15/012; B23K 9/007; B32B 3/266; B32B 7/12; B23K 2103/20; B32B 2605/00

(57) ABSTRACT

A clad metal structure includes: a clad metal portion including a first material layer having at least one material through-hole disposed therethrough, and a second material layer including a material dissimilar from the first material layer and attached to a surface of the first material layer to form an integrated structure; and a welding target portion including a same material as the second material layer, and welded to the second material layer at a position corresponding to the material through-hole.

### CROSS-REFERENCE TO RELATED APPLICATION

The present application claims priority and the benefit of Korean Patent Application No. 10-2024-0136814, filed on Oct. 8, 2024 in the Korean Intellectual Property Office, the entire disclosure of which is incorporated herein by reference.

### BACKGROUND

### Field

Exemplary embodiments of the present disclosure relate to a clad metal structure, and more particularly, to a clad metal structure capable of improving weldability of clad metal formed by joining dissimilar materials.

### Discussion of the Background

Various materials are applied to automotive components in order to reduce the weight and cost of vehicles. Because materials used in automotive components are frequently subjected to welding, excellent weldability is required.

To address the above-described issue, a material such as clad metal has attracted attention. Clad metal is formed by rolling dissimilar thin plate materials to form multiple layers, thereby integrating properties of respective base materials.

Because clad metal is formed by joining dissimilar plate materials, not only an outer layer material but also an inner core material may melt together during welding, thereby generating intermetallic compounds as a weld bead is formed. As a result, there is a problem in that welding quality deteriorates. Accordingly, there is a need for improvement.

The background art of the present disclosure is disclosed in Korean Patent No. 10-2098483 (registered on Apr. 1, 2020, entitled “LOW-DENSITY CLAD STEEL SHEET HAVING EXCELLENT FORMABILITY AND FATIGUE PROPERTY, AND METHOD FOR MANUFACTURING THE SAME”).

### SUMMARY

Various embodiments are directed to providing a clad metal structure capable of improving weldability of clad metal formed by joining dissimilar materials.

In an embodiment, a clad metal structure according to the present disclosure includes: a clad metal portion comprising a first material layer including at least one material through-hole disposed therethrough, and a second material layer including a material dissimilar from the first material layer and attached to a surface of the first material layer to form an integrated structure; and a welding target portion including the same material as the second material layer, and welded to the second material layer at a position corresponding to the material through-hole.

The welding target portion may include at least one welding through-hole disposed therethrough. The welding target portion and the second material layer may be welded at a position at which the welding through-hole and the material through-hole overlap each other.

The welding through-hole may be smaller than the material through-hole.

The welding through-hole and the material through-hole may each have an elongated-hole shape extending in the same direction.

The welding through-hole and the material through-hole may each have a concentric circular shape.

The welding through-hole may be larger than an outer diameter of a tip of a welding rod.

The first material layer may include an aluminum material. The second material layer may include a steel material.

The first material layer and the second material layer may be rolled by a rolling machine to form the integrated structure.

The second material layer may be attached to at least one of a first surface and a second surface of the first material layer.

The second material layer and the welding target portion may be joined by spot welding.

In an embodiment, a cross member including a clad metal structure according to the present disclosure may include: a reinforcement to which the clad metal portion is applied; and a lower panel to which the welding target portion is applied and the reinforcement is welded.

The first material layer may include an aluminum material, the second material layer may include a steel material, and the first material layer may include the material through-hole formed therethrough.

In an embodiment, a dust cover including a clad metal structure according to the present disclosure may include: a dust shield to which the clad metal portion is applied; and a dust ring to which the welding target portion is applied and the dust shield is welded.

The first material layer may include an aluminum material, the second material layer may include a steel material, and the first material layer may include the material through-hole formed therethrough.

The dust shield may be welded to an outer surface of the dust ring.

According to a clad metal structure of the present disclosure, a clad metal portion formed by joining dissimilar materials includes a material through-hole formed therethrough, so that generation of an intermetallic compound can be prevented during welding with a welding target portion, thereby enabling a firm weld joint between the clad metal portion and the welding target portion.

According to the present disclosure, weldability between the clad metal portion and the welding target portion may be improved, thereby increasing applicability to vehicle components and the like.

### BRIEF DESCRIPTION OF THE DRAWINGS

FIG. 1 is a perspective view schematically illustrating a clad metal structure according to an embodiment of the present disclosure.

FIG. 2 is a conceptual diagram schematically illustrating formation of a material through-hole in a first material layer through a punching process according to an embodiment of the present disclosure.

FIG. 3 is a conceptual diagram schematically illustrating integration of the first material layer and a second material layer through a rolling process according to an embodiment of the present disclosure.

FIG. 4 is a schematic sectional view taken along line A-A of FIG. 1.

FIG. 5 is a conceptual diagram schematically illustrating a welding target portion being welded to a clad metal portion according to an embodiment of the present disclosure.

FIG. 6 is an exploded perspective view schematically illustrating a clad metal structure according to another embodiment of the present disclosure.

FIG. 7 is a conceptual diagram schematically illustrating a welding target portion being welded to a clad metal portion according to another embodiment of the present disclosure.

FIG. 8 is a plan view schematically illustrating the welding target portion being welded to the clad metal portion according to another embodiment of the present disclosure.

FIG. 9 is a conceptual diagram schematically illustrating a welding target portion being welded to a clad metal portion according to still another embodiment of the present disclosure.

FIG. 10 is a plan view schematically illustrating the welding target portion being welded to the clad metal portion according to still another embodiment of the present disclosure.

FIG. 11 is a front view schematically illustrating an example in which a clad metal portion and a welding target portion according to the present disclosure are applied to a cross member of a vehicle.

FIG. 12 is a partially enlarged perspective view schematically illustrating an example in which the clad metal portion and the welding target portion according to the present disclosure are applied to the cross member of the vehicle.

FIG. 13 is a perspective view schematically illustrating, from one direction, an example in which the clad metal portion according to the present disclosure is applied to the cross member of the vehicle.

FIG. 14 is a perspective view schematically illustrating, from another direction, an example in which the clad metal portion according to the present disclosure is applied to the cross member of the vehicle.

FIG. 15 is a perspective view schematically illustrating an example in which the clad metal portion and the welding target portion according to the present disclosure are assembled to the cross member of the vehicle.

FIG. 16 is a perspective view schematically illustrating an example in which a clad metal portion and a welding target portion according to the present disclosure are applied to a dust cover of a vehicle.

FIG. 17 is a front view schematically illustrating an example in which the clad metal portion and the welding target portion according to the present disclosure are applied to the dust cover of the vehicle.

FIG. 18 is a partially enlarged front view schematically illustrating an example in which the clad metal portion and the welding target portion according to the present disclosure are applied to the dust cover of the vehicle.

### DETAILED DESCRIPTION

Hereinafter, a clad metal structure according to the present disclosure will be described with reference to the accompanying drawings. It should be noted that the drawings may be exaggerated in thickness of lines or sizes of components for descriptive convenience and clarity.

Furthermore, the terms as used herein are defined by taking functions of the present disclosure into account and can be changed according to the custom or intention of users or operators. Therefore, definition of the terms should be made according to the overall disclosures set forth herein.

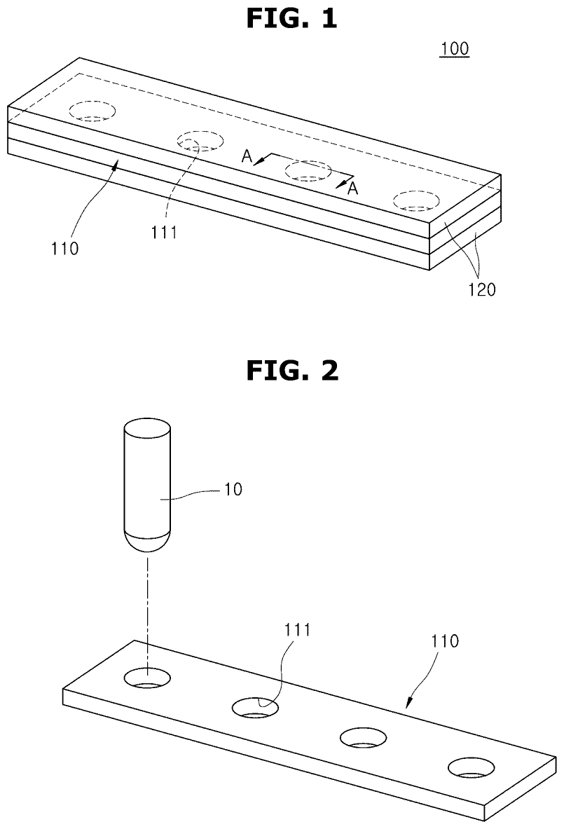

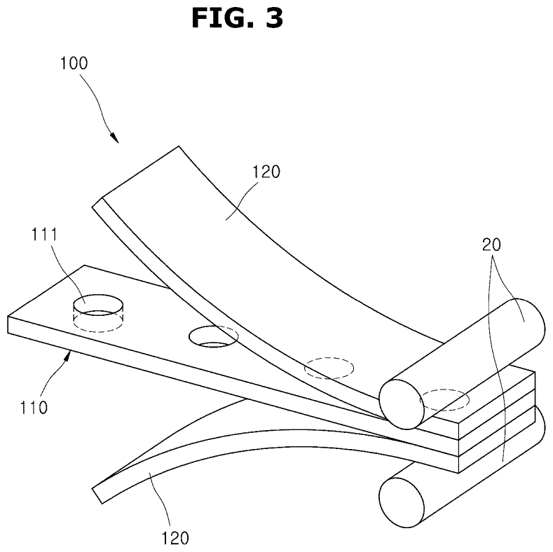

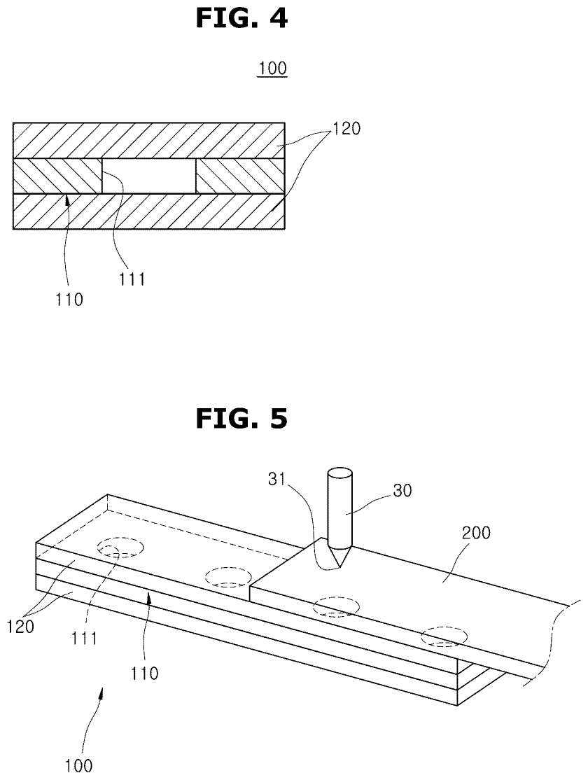

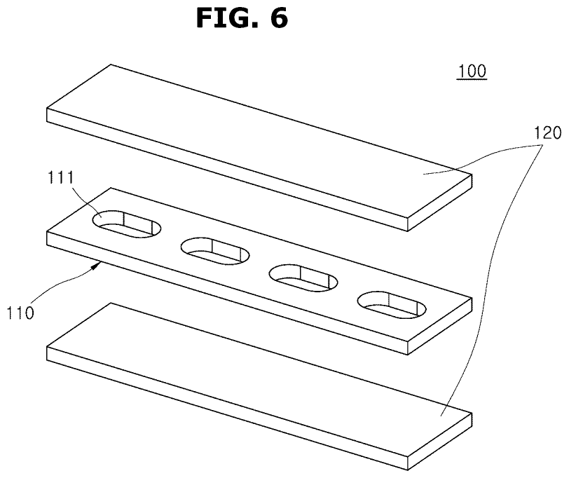

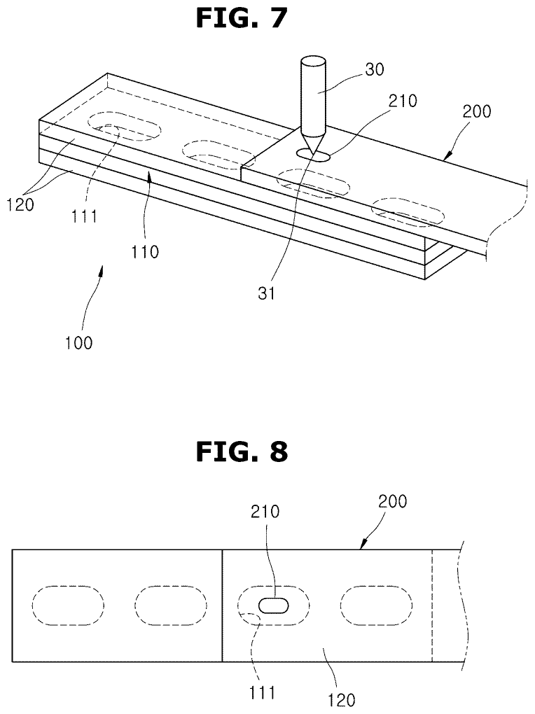

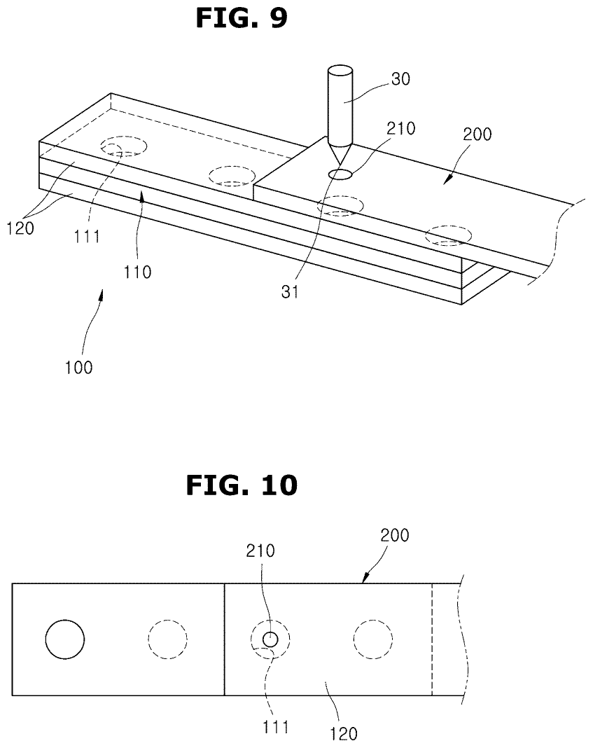

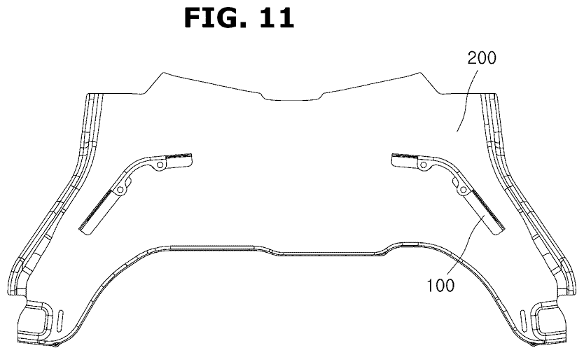

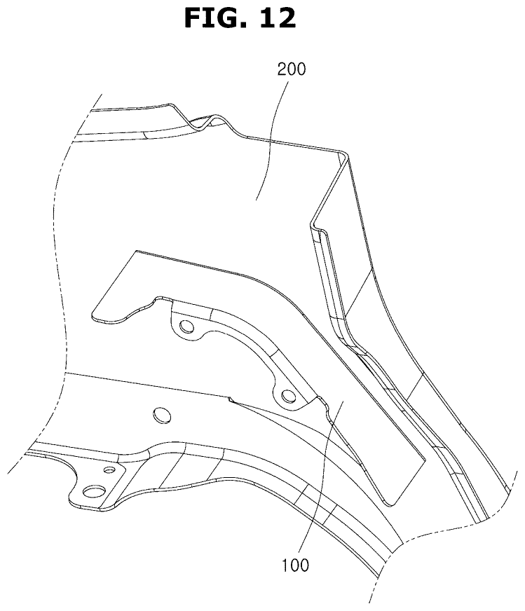

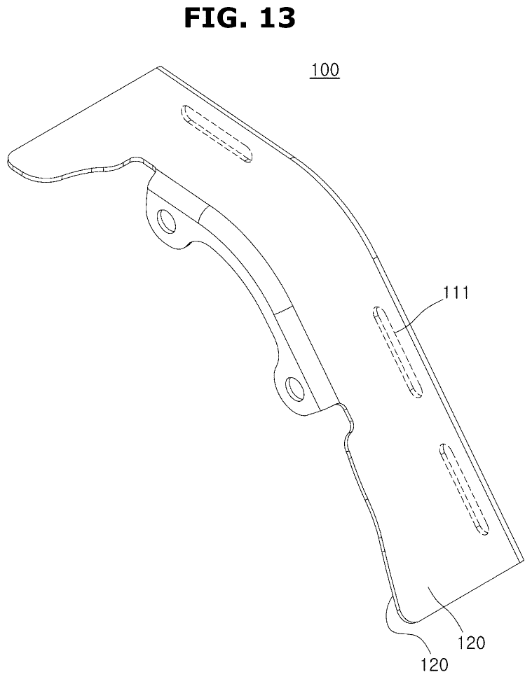

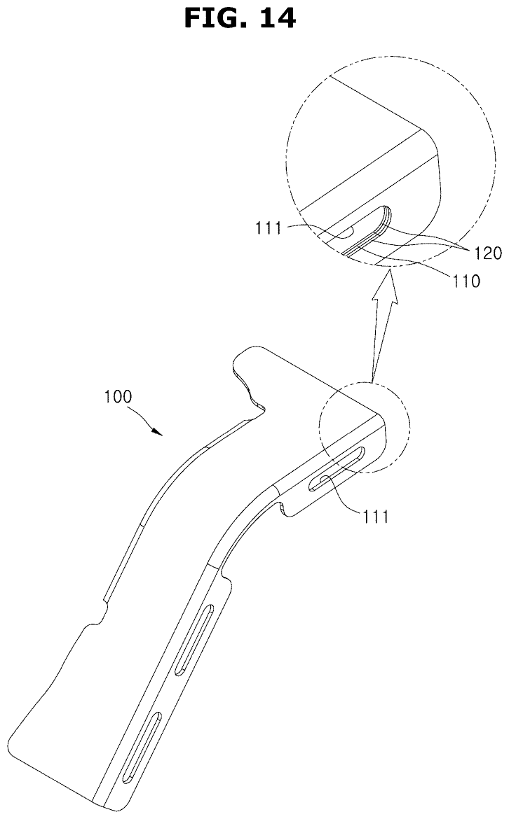

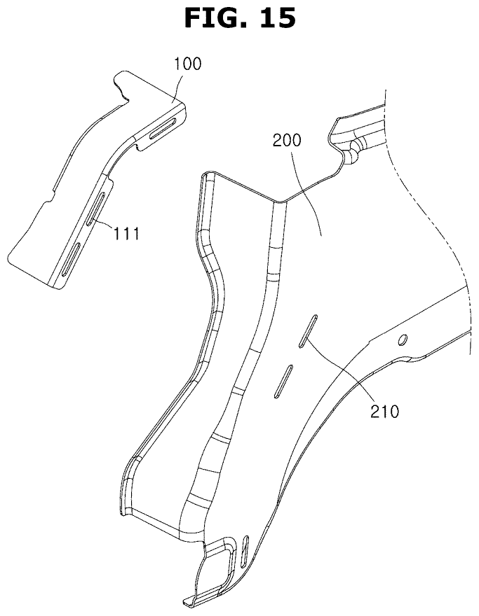

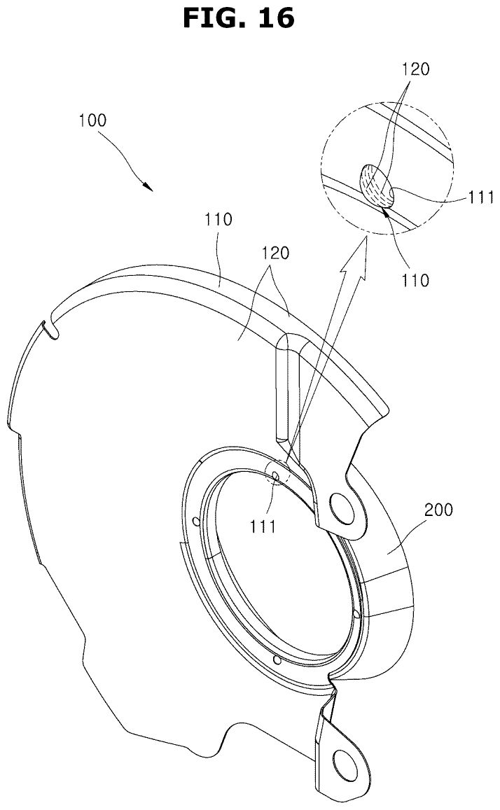

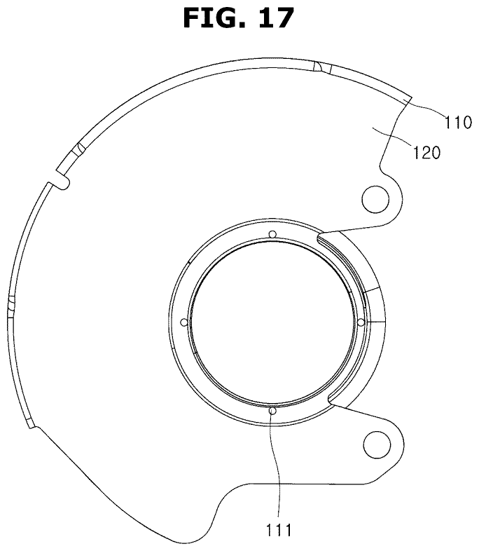

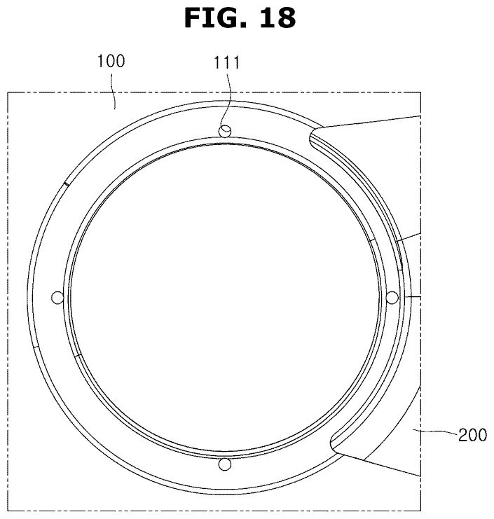

FIG. 1 is a perspective view schematically illustrating a clad metal structure according to an embodiment of the present disclosure. FIG. 2 is a conceptual diagram schematically illustrating formation of a material through-hole in a first material layer through a punching process according to an embodiment of the present disclosure. FIG. 3 is a conceptual diagram schematically illustrating integration of the first material layer and a second material layer through a rolling process according to an embodiment of the present disclosure. FIG. 4 is a schematic sectional view taken along line A-A of FIG. 1. FIG. 5 is a conceptual diagram schematically illustrating a welding target portion being welded to a clad metal portion according to an embodiment of the present disclosure. FIG. 6 is an exploded perspective view schematically illustrating a clad metal structure according to another embodiment of the present disclosure. FIG. 7 is a conceptual diagram schematically illustrating a welding target portion being welded to a clad metal portion according to another embodiment of the present disclosure. FIG. 8 is a plan view schematically illustrating the welding target portion being welded to the clad metal portion according to another embodiment of the present disclosure. FIG. 9 is a conceptual diagram schematically illustrating a welding target portion being welded to a clad metal portion according to still another embodiment of the present disclosure. FIG. 10 is a plan view schematically illustrating the welding target portion being welded to the clad metal portion according to still another embodiment of the present disclosure. FIG. 11 is a front view schematically illustrating an example in which a clad metal portion and a welding target portion according to the present disclosure are applied to a cross member of a vehicle. FIG. 12 is a partially enlarged perspective view schematically illustrating an example in which the clad metal portion and the welding target portion according to the present disclosure are applied to the cross member of the vehicle. FIG. 13 is a perspective view schematically illustrating, from one direction, an example in which the clad metal portion according to the present disclosure is applied to the cross member of the vehicle. FIG. 14 is a perspective view schematically illustrating, from another direction, an example in which the clad metal portion according to the present disclosure is applied to the cross member of the vehicle. FIG. 15 is a perspective view schematically illustrating an example in which the clad metal portion and the welding target portion according to the present disclosure are assembled to the cross member of the vehicle. FIG. 16 is a perspective view schematically illustrating an example in which a clad metal portion and a welding target portion according to the present disclosure are applied to a dust cover of a vehicle. FIG. 17 is a front view schematically illustrating an example in which the clad metal portion and the welding target portion according to the present disclosure are applied to the dust cover of the vehicle. FIG. 18 is a partially enlarged front view schematically illustrating an example in which the clad metal portion and the welding target portion according to the present disclosure are applied to the dust cover of the vehicle.

Referring to FIGS. 1 to 18, a clad metal structure according to an embodiment of the present disclosure may include a clad metal portion 100 and a welding target portion 200.

The clad metal part 100 may be formed of dissimilar materials, including a first material layer 110 and a second material layer 120. The first material layer 110 may include at least one material through-hole 111 formed therethrough. A plurality of material-through holes 111 may be formed through the first material layer 110.

Referring to FIG. 2, each material through-hole 111 may be formed through the first material layer 110 by a punching machine 10. The punching machine 10 may apply pressure to the first material layer 110, thereby forming the material through-hole 111 through the first material layer 110.

In FIG. 2, the material through-holes 111 are illustrated as being formed through the first material layer 110 at uniform intervals, but are not limited thereto. The positions at which the material through-holes 111 are formed through may vary depending on the shape of a work target.

The second material layer 120 may be formed of a dissimilar material from the first material layer 110, and may be attached to a surface of the first material layer 110 to be integrated therewith. The second material layer 120 may be attached to at least one of a first surface (a lower surface based on FIG. 1) and a second surface (an upper surface based on FIG. 1) of the first material layer 110. That is, the second material layer 120 may be attached only to the first surface of the first material layer 110, only to the second surface of the first material layer 110, or to both the first surface and the second surface of the first material layer 110.

The first material layer 110 and the second material layer 120 may be formed of dissimilar materials having different properties. The first material layer 110 may be formed to include an aluminum material, and the second material layer 120 may be formed to include a steel material. In other words, the clad metal portion 100 may be formed in a steel-aluminum-steel combination.

The first material layer 110 may be formed of an aluminum material, and the second material layer 120 may be formed of a steel material attached to an outer side of the first material layer 110, thereby reducing production cost, achieving weight reduction, and maintaining rigidity.

Alternatively, the first material layer 110 may be formed to include a steel material, and the second material layer 120 may be formed to include an aluminum material. In other words, the clad metal portion 100 may be formed in an aluminum-steel-aluminum combination.

The first material layer 110 may be formed of a steel material, and the second material layer 120 may be formed of an aluminum material attached to an outer side of the first material layer 110. Due to the properties of the aluminum material, separate rustproof treatment may not be required, thereby reducing the cost for rustproof treatment and maintaining rust resistance.

Alternatively, the first material layer 110 and the second material layer 120 may each be provided as a single layer. That is, the first material layer 110 may be formed to include a steel material, and the second material layer 120 may be formed to include an aluminum material, so that the clad metal portion 100 may be formed in a steel-aluminum combination.

Alternatively, the first material layer 110 may be formed to include an aluminum material, and the second material layer 120 may be formed to include a steel material, so that the clad metal portion 100 may be formed in an aluminum-steel combination.

The first material layer 110 and the second material layer 120 may be rolled by a rolling machine 20 to be integrated with each other. The first material layer 110 and the second material layer 120 may be placed in an overlapped state. The rolling machine 20 may apply pressure from above and below to the first material layer 110 and second material layer 120 that are overlapped with each other, thereby integrating the first material layer 110 and the second material layer 120.

A void may be formed at the material through-hole 111 in the first material layer 110 and the second material layer 120.

The rolling machine 20 may be configured as a pair of rollers arranged vertically to face the second material layer 120 disposed on the outer side of the first material layer 110. The rollers of the rolling machine 20 may each be formed in a cylindrical shape, and may apply a set pressure to the first material layer 110 and the second material layer 120 while rotating.

The welding target portion 200 may be formed of the same material as the second material layer 120 and may be welded to the second material layer 120 at a position corresponding to the material through-hole 111. For example, in the case where the second material layer 120 is formed of a steel material, the welding target portion 200 may be formed of a steel material that is the same material as the second material layer 120. In the case where the second material layer 120 is formed of an aluminum material, the welding target portion 200 may be formed of an aluminum material that is the same material as the second material layer 120.

The welding target portion 200 may be welded to the second material layer 120 at a position corresponding to the material through-hole 111. In other words, the welding target portion 200 may be welded to the second material layer 120 at the position corresponding to the material through-hole 111, at which the first material layer 110 and the second material layer 120 form a void. Accordingly, the transfer of welding heat to the first material layer 110 may be prevented by the material through-hole 111, thereby blocking the formation of intermetallic compounds between the first material layer 110 and the second material layer 120. As a result, weldability between the welding target portion 200 and the second material layer 120 may be improved.

Referring to FIGS. 7 to 10, the welding target portion 200 may include at least one welding through-hole 210 formed therethrough. The welding through-hole 210 of the welding target portion 200 may be formed at a position and in a number corresponding to the material through-hole 111 of the first material layer 110.

The welding through-hole 210 may be formed according to the shape of the material through-hole 111. The welding through-hole 210 may be formed smaller than the material through-hole 111. That is, the size of the welding through-hole 210 may be smaller than the size of the material through-hole 111. Forming the welding through-hole 210 smaller than the material through-hole 111 may reduce the influence of welding heat transferred from a welding rod 30 on the material through-hole 111.

The welding target portion 200 and the second material layer 120 may be welded by a welding machine at a position where the welding through-hole 210 and the material through-hole 111 overlap. The welding machine may include a spot welding machine.

The second material layer 120 and the welding target portion 200 may be joined by spot welding. In a state in which the welding target portion 200 is in contact with the upper second material layer 120, the welding rod 30 of the welding machine may concentrate current and pressure on the welding target portion 200 and the lower second material layer 120, locally heat the weld region, and perform welding by applying pressure using an electrode.

Because spot welding is a type of local welding, deformation of the welding target portion 200, the second material layer 120, and the first material layer 110 may be reduced, and the time required for welding may be shortened.

Referring to FIGS. 7 and 8, the welding through-hole 210 and the material through-hole 111 may each be formed in an elongated-hole shape. The welding through-hole 210 and the material through-hole 111 may each be formed in an elongated-hole shape extending in the same direction (left-right direction based on FIGS. 7 and 8). The elongated-hole shape of the welding through-hole 210 and the elongated-hole shape of the material through-hole 111 may be formed to extend predefined lengths in the same direction.

The material through-hole 111 having an elongated-hole shape may be formed through the first material layer 110 by the punching machine 10. The welding through-hole 210 having an elongated-hole shape may be formed through the welding target portion 200 by the punching machine 10.

In an embodiment, the welding through-hole 210 may be formed smaller than the material through-hole 111. The punching machine 10 may punch the welding through-hole 210 and the material through-hole 111 such that the welding through-hole 210 having an elongated-hole shape is smaller than the material through-hole 111 having an elongated-hole shape.

In the present disclosure, the material through-hole 111 and the welding through-hole 210 may be formed taking into account an outer diameter of a tip 31 of the welding rod 30 used in spot welding. In other words, the material through-hole 111 and the welding through-hole 210 may be punched through by the punching machine 10 to have a size greater than the outer diameter of the tip 31 of the welding rod 30. The tip 31 of the welding rod 30 may refer to an end (i.e., a lower end based on FIG. 7) of the welding rod 30 that comes into contact with the second material layer 120.

The welding through-hole 210 having an elongated-hole shape may be formed smaller than the material through-hole 111 having an elongated-hole shape, thereby reducing the effect of the welding heat transferred from the welding rod 30 on the material through-hole 111.

Referring to FIGS. 9 and 10, the welding through-hole 210 and the material through-hole 111 may each be formed in a circular shape. The welding through-hole 210 and the material through-hole 111 may be each formed in a concentric circular shape. That is, the welding through-hole 210 and the material through-hole 111 may be formed through the second material layer 120 and the first material layer 110, respectively, as concentric circles having the same center.

The material through-hole 111 having a circular shape may be formed through the first material layer 110 by the punching machine 10. The welding through-hole 210 having a circular shape may be formed through the welding target portion 200 by the punching machine 10.

In an embodiment, the welding through-hole 210 may be formed smaller than the material through-hole 111. The punching machine 10 may punch the material through-hole 111 and the welding through-hole 210 such that the welding through-hole 210 having a circular shape is smaller than the material through-hole 111 having a circular shape.

Because the welding through-hole 210 having a circular shape is formed smaller than the material through-hole 111 having a circular shape, the effect of the welding heat transferred from the welding rod 30 on the material through-hole 111 can be reduced.

The welding through-hole 210 may be formed larger than the outer diameter of the welding rod 30 of the welding machine. The welding rod 30 may be formed in a cylindrical shape. The outer diameter of the welding rod 30 may be smaller than an inner size of the welding through-hole 210, so that welding is performed in a localized manner between the edge of the welding through-hole 210 and the second material layer 120, thereby reducing the transfer of welding heat, and minimizing deformation of the welding target portion 200, the second material layer 120, and the first material layer 110.

FIGS. 11 to 15 illustrate an example in which the present disclosure is applied to a cross member, which is one of components of a vehicle. The cross member may be formed by joining a lower panel and a reinforcement. The lower panel may form a main body of the cross member, and the reinforcement may be joined to the lower panel to reinforce the lower panel.

In the present disclosure, the clad metal portion 100 may be applied to the reinforcement, and the welding target portion 200 may be applied to the lower panel.

The clad metal portion 100 of the reinforcement may be welded to the welding target portion 200 of the lower panel by the welding rod 30 of the welding machine. The lower panel may be formed of a steel plate, and the reinforcement may be formed of a steel-aluminum-steel combination. That is, the clad metal portion 100 of the reinforcement may include the first material layer 110 and the second material layer 120. The first material layer 110 may be formed of aluminum, and the second material layer 120 may be formed of steel. The first material layer 110 may include a material through-hole 111 formed therethrough.

As a reinforcement joined to the lower panel, the clad metal portion 100 having a steel-aluminum-steel combination may be configured, thereby reducing weight and production cost compared to steel material.

FIGS. 16 to 18 illustrate an example in which the present disclosure is applied to a dust cover, which is one of components of a vehicle. The dust cover may be formed by joining a dust shield and a dust ring. The dust shield may be welded and joined to an outer surface of the dust ring.

In the present disclosure, the clad metal portion 100 may be applied as the dust shield, and the welding target portion 200 may be applied as the dust ring.

The clad metal portion 100 of the dust shield may be welded to the welding target portion 200 of the dust ring by the welding rod 30 of the welding machine. The dust ring may be formed of a steel plate, and the dust shield may be formed in a steel-aluminum-steel configuration. That is, the clad metal portion 100 of the dust shield may include the first material layer 110 and the second material layer 120. The first material layer 110 may be formed of aluminum, and the second material layer 120 may be formed of steel. The first material layer 110 may include a material through-hole 111 formed therethrough.

As a dust shield joined to the dust ring, the clad metal portion 100 having a steel-aluminum-steel combination may be configured, thereby reducing weight and production cost compared to steel material.

Although the cross member and the dust cover have been described as examples of vehicle components to which the clad metal portion 100 and the welding target portion 200 according to the present disclosure are applied, the present disclosure is not limited thereto and may be applied to various vehicle components requiring reductions in weight and production cost.

According to the clad metal structure of the present disclosure, the clad metal portion 100 formed by joining dissimilar materials includes the material through-hole 111 formed therethrough, so that generation of an intermetallic compound can be prevented during welding with the welding target portion 200, thereby enabling a firm weld joint between the clad metal portion 100 and the welding target portion 200.

According to the present disclosure, weldability between the clad metal portion 100 and the welding target portion 200 may be improved, thereby increasing applicability to vehicle components and the like.

Although specific embodiments of the present disclosure have been described, the spirit and scope of the present disclosure are not limited to the specific embodiments, and various modifications may be made by those skilled in the art to which the present disclosure pertains without departing from the gist of the present disclosure as defined in the claims.

What is claimed is:

1. A clad metal structure, comprising:
a clad metal portion comprising a first material layer including at least one material through-hole disposed therethrough, and a second material layer comprising a material dissimilar from the first material layer and attached to a surface of the first material layer to form an integrated structure; and
a welding target portion comprising a same material as the second material layer, and welded to the second material layer at a position corresponding to the material through-hole.

2. The clad metal structure of claim 1,
wherein the welding target portion includes at least one welding through-hole disposed therethrough, and
wherein the welding target portion and the second material layer are welded at a position at which the welding through-hole and the material through-hole overlap each other.

3. The clad metal structure of claim 2, wherein the welding through-hole is smaller than the material through-hole.

4. The clad metal structure of claim 2, wherein the welding through-hole and the material through-hole each have an elongated-hole shape extending in a same direction.

5. The clad metal structure of claim 2, wherein the welding through-hole and the material through-hole each have a concentric circular shape.

6. The clad metal structure of claim 2, wherein the welding through-hole is larger than an outer diameter of a tip of a welding rod.

7. The clad metal structure of claim 1,
wherein the first material layer includes an aluminum material, and
wherein the second material layer includes a steel material.

8. The clad metal structure of claim 1, wherein the first material layer and the second material layer are rolled by a rolling machine to form the integrated structure.

9. The clad metal structure of claim 1, wherein the second material layer is attached to at least one of a first surface and a second surface of the first material layer.

10. The clad metal structure of claim 1, wherein the second material layer and the welding target portion are joined by spot welding.

11. A cross member including a clad metal structure, the cross member comprising:
a reinforcement to which the clad metal portion according to claim 1 is applied; and
a lower panel to which the welding target portion according to claim 1 is applied and the reinforcement is welded.

12. The cross member of claim 11, wherein the first material layer includes an aluminum material, the second material layer includes a steel material, and the first material layer includes the material through-hole disposed therethrough.

13. A dust cover including a clad metal structure, the dust cover comprising:
a dust shield to which the clad metal portion according to claim 1 is applied; and
a dust ring to which the welding target portion according to claim 1 is applied and the dust shield is welded.

14. The dust cover of claim 13, wherein the first material layer includes an aluminum material, the second material layer includes a steel material, and the first material layer includes the material through-hole disposed therethrough.

15. The dust cover of claim 13, wherein the dust shield is welded to an outer surface of the dust ring.
